(19) United States
(12) Patent Application Publication
(10) Pub. No.: US 2012/0136519 A1
(43) Pub. Date: May 31, 2012

(54) MOTOR VEHICLE

(75) Inventor: Takashi Suzuki, Gotenba-shi (JP)

(73) Assignee: TOYOTA JIDOSHA KABUSHIKI KAISHA, Toyota-shi (JP)

(21) Appl. No.: 13/306,143

(22) Filed: Nov. 29, 2011

(30) Foreign Application Priority Data
Nov. 29, 2010 (JP) 2010-264569

(51) Int. Cl. F02D 28/00; B60W 20/00; B60W 10/04

(52) U.S. Cl. 701/22; 701/102; 180/65.265

(57) ABSTRACT

When cooling water temperature of the engine is not less than the water temperature threshold value, the target drive point of the engine is set based on the fuel economy optimized operation curve and the power demand of the engine, without allowing selection of the operation curve between the fuel economy optimized operation curve to drive the engine efficiently and the operation curve to drive the engine with less efficiency than the efficiency on the fuel economy optimized operation curve in at least a part of the operating area to avoid operation in the muffled area. Then, the engine is driven at the target drive point and the hybrid vehicle is driven with a torque corresponding to the torque demand. This effectively prevents the temperature rise in the cooling water for cooling of the engine due to increase in heat loss of the engine, and prevents overheating of the engine.

### BACKGROUND OF THE INVENTION

1. Field of the Invention

The present invention relates to a motor vehicle.

2. Description of the Prior Art

In one proposed motor vehicle that is a hybrid vehicle, a power from an engine is output to a driveshaft linked to an axle of the motor vehicle through torque conversion in a first motor (MG1) and a planetary gear mechanism, and a power from a second motor (MG2) is output to the driveshaft via a gear mechanism such as a transmission, in order for the hybrid vehicle to be driven. In the hybrid vehicle, there is a case that the output torque of the motor MG2 becomes close to zero when a target drive point of the engine and torque commands of the two motors are set using a constraint (operation curve) for efficient operation of the engine. In this case, the target drive point and the torque commands are set again for the motor MG2 to output a different torque from the torque close to zero (see, for example, Patent Document 1). In this vehicle, the target drive point of the engine is set again to a drive point different from the drive point for efficient operation of the engine as described above, and the setting prevents unusual sound from the gear mechanism resulting from the output torque of the motor MG2 close to zero.
Patent Document 1: Japanese Patent Laid-Open No. 2006-262585

### SUMMARY OF THE INVENTION

The engine overheating may possibly occur due to temperature rise in cooling water for cooling of the engine when the engine is driven at a drive point different from the drive point for efficient operation as is the case in the above vehicle. Part of heat energy produced from explosive combustion in the engine becomes heat loss of radiation from the cylinder surface to the cooling water. When the state that the engine is driven at a drive point different from the drive point for efficient operation happens frequently or continuously, temperature rise in the engine cooling water may possibly occur resulting in the engine overheating, due to increase in heat loss while outputting an identical power from the engine.

In the motor vehicle of the invention, the main object of the invention is to prevent temperature rise in cooling liquid for cooling of the internal combustion engine.

In order to attain the main object, the motor vehicle of the invention has the configurations discussed below.

According to one aspect, the present invention is directed to a first motor vehicle. The first motor vehicle has: an internal combustion engine; a power transmitting unit that is connected with a driveshaft linked to an axle of the motor vehicle and with an output shaft of the internal combustion engine in such a manner as to be rotatable independently of the driveshaft and configured to transmit at least part of power from the output shaft to the driveshaft; a cooling liquid temperature detector that detects a temperature of cooling liquid for cooling of the internal combustion engine; a power demand setting module that sets a power demand required for the internal combustion engine according to a driving power demand for driving the motor vehicle; a target drive point setting module that sets a target drive point where the internal combustion engine is to be driven, in a case that the detected temperature of the cooling liquid is less than a predetermined temperature threshold value, based on the set power demand and one selected constraint between a first constraint for efficient operation of the internal combustion engine and a second constraint for less efficient operation of the internal combustion engine than the first constraint in at least a part of an operating area of the internal combustion engine, while setting the target drive point based on the set power demand and the first constraint without allowing selection of the second constraint in a case that the detected temperature of the cooling liquid is not less than the temperature threshold value; and a control module that controls the internal combustion engine and the power transmitting unit so that the internal combustion engine is driven at the set target drive point and the motor vehicle is driven with a driving power corresponding to the driving power demand.

In the first motor vehicle according to this aspect of the invention, a target drive point where the internal combustion engine is to be driven is set based on a power demand required for the internal combustion engine set according to a driving power demand for driving the motor vehicle and one selected constraint between a first constraint for efficient operation of the internal combustion engine and a second constraint for less efficient operation of the internal combustion engine than the first constraint in at least a part of an operating area of the internal combustion engine, in a case that a temperature of cooling liquid for cooling of the internal combustion engine is less than a predetermined temperature threshold value. On the other hand, the target drive point is set based on the power demand and the first constraint without allowing selection of the second constraint, in a case that the temperature of the cooling liquid is not less than the temperature threshold value. Then, the internal combustion engine and the power transmitting unit are controlled so that the internal combustion engine is driven at the target drive point and the motor vehicle is driven with a driving power corresponding to the driving power demand. Accordingly, in the case that the temperature of the cooling liquid is not less than the temperature threshold value, it is not allowed to drive the internal combustion engine with less efficiency than the efficiency in the first constraint. This effectively prevents the temperature rise in the cooling liquid due to increase in loss of the internal combustion engine. As a result, overheating of the internal combustion engine is effectively prevented. In this arrangement of the invention, the target drive point setting module may set the target drive point using, as the temperature threshold value, a lower limit value of a temperature range where a temperature rise in the cooling liquid is to be prevented. And, in this arrangement of the invention, the first constraint may be a constraint defining a relation between rotation speed and torque for the most efficient operation of the internal combustion engine while the internal combustion engine outputs an identical power.

In one preferable application of the first motor vehicle of the invention, the target drive point setting module may set the target drive point using, as the second constraint, a constraint defining a relation between a rotation speed and a torque for efficient operation of the internal combustion engine in an operating area other than a predetermined operating area where noise or vibration caused by operation of the internal combustion engine may give feeling of incompatibility to a passenger. This arrangement enables to make a selection between driving the internal combustion engine efficiently and preventing to give feeling of incompatibility to a passenger due to noise or vibration, in the case that the temperature of the cooling liquid is less than the temperature threshold value. In this arrangement of the invention, the target drive point setting module, in the case that the detected temperature of the cooling liquid is less than the temperature threshold value, may set the target drive point based on the set power demand and the first constraint when a vehicle speed of the motor vehicle is not less than a vehicle speed threshold value predetermined as a lower limit value of a vehicle speed range where it is supposed that the noise or vibration does not give feeling of incompatibility to a passenger, while setting the target drive point based on the set power demand and the second constraint when the vehicle speed is less than the vehicle speed threshold value. This arrangement enables, in comparison with the case that the target drive point is set based on the second constraint regardless of the vehicle speed when the temperature of the cooling liquid is less than the temperature threshold value, to drive the internal combustion engine efficiently and prevent occurrence of the noise or vibration in operation of the internal combustion engine effectively.

In another preferable application of the first motor vehicle of the invention, the target drive point setting module may set the target drive point using, as the second constraint, a constraint defining a relation between rotation speed and torque for giving a higher priority to outputting torque than efficient operation of the internal combustion engine. This arrangement enables to make a selection between driving the internal combustion engine efficiently and giving a higher priority to outputting torque than efficient operation of the internal combustion engine, in the case that the temperature of the cooling liquid is less than the temperature threshold value. In this arrangement of the invention, the target drive point setting module, in the case that the detected temperature of the cooling liquid is less than the temperature threshold value, may set the target drive point based on the set power demand and the first constraint when an accelerator opening is less than an accelerator opening threshold value predetermined as a lower limit value of an accelerator opening range forgiving a higher priority to outputting torque than efficient operation of the internal combustion engine, while setting the target drive point based on the set power demand and the second constraint when the accelerator opening is not less than the accelerator opening threshold value. This arrangement enables, in the case that the detected temperature of the cooling liquid is less than the temperature threshold value, to drive the internal combustion engine efficiently when the driver of the motor vehicle requires to output relatively low torque for driving the vehicle while outputting high torque from the internal combustion engine when the driver requires to output relatively high torque for driving the vehicle.

According to another aspect, the present invention is directed to a second motor vehicle. The second motor vehicle has: an internal combustion engine; a power transmitting unit that is connected with a driveshaft linked to an axle of the motor vehicle and with an output shaft of the internal combustion engine in such a manner as to be rotatable independently of the driveshaft and configured to transmit at least part of power from the output shaft to the driveshaft; a cooling liquid temperature detector that detects a temperature of cooling liquid for cooling of the internal combustion engine; a power demand setting module that sets a power demand required for the internal combustion engine according to a driving power demand for driving the motor vehicle; a target drive point setting module that sets a target drive point where the internal combustion engine is to be driven, in a case that the detected temperature of the cooling liquid is less than a predetermined temperature threshold value, based on the set power demand and a noise vibration constraint that is a constraint defining a relation between rotation speed and torque for efficient operation of the internal combustion engine in an operating area other than a predetermined operating area where noise or vibration caused by operation of the internal combustion engine may give feeling of incompatibility to a passenger, while setting the target drive point based on the set power demand and an efficiency constraint that is a constraint for efficient operation of the internal combustion engine in a case that the detected temperature of the cooling liquid is not less than the temperature threshold value; and a control module that controls the internal combustion engine and the power transmitting unit so that the internal combustion engine is driven at the set target drive point and the motor vehicle is driven with a driving power corresponding to the driving power demand.

In the second motor vehicle according to this aspect of the invention, a target drive point where the internal combustion engine is to be driven is set based on a power demand required for the internal combustion engine set according to a driving power demand for driving the motor vehicle and a noise vibration constraint that is a constraint defining a relation between rotation speed and torque for efficient operation of the internal combustion engine in an operating area other than a predetermined operating area where noise or vibration caused by operation of the internal combustion engine may give feeling of incompatibility to a passenger, in a case that a temperature of cooling liquid for cooling of the internal combustion engine is less than a predetermined temperature threshold value. On the other hand, the target drive point is set based on the power demand and an efficiency constraint that is a constraint for efficient operation of the internal combustion engine, in a case that the temperature of the cooling liquid is not less than the temperature threshold value. Then, the internal combustion engine and the power transmitting unit are controlled so that the internal combustion engine is driven at the target drive point and the motor vehicle is driven with a driving power corresponding to the driving power demand. Accordingly, in comparison with the case of driving the internal combustion engine at a drive point that is based on the noise vibration constraint regardless of the temperature of the cooling liquid, the internal combustion engine is driven more efficiently. This effectively prevents the temperature rise in the cooling liquid due to increase in loss of the internal combustion engine. As a result, overheating of the internal combustion engine is effectively prevented. Needless to say, in the case that the temperature of the cooling liquid is less than the temperature threshold value, the occurrence of noise or vibration in operation of the internal combustion engine is effectively prevented and giving feeling of incompatibility to a passenger is effectively prevented. In this arrangement of the invention, the first constraint may be a constraint defining a relation between rotation speed and torque for the most efficient operation of the internal combustion engine while the internal combustion engine outputs an identical power.

In one preferable application of the first vehicle or the second vehicle of the invention, the motor vehicle may further have: a secondary battery; and a motor constructed to transmit electric power to and from the secondary battery and to input and output power from and to the driveshaft, and the power transmitting unit may have a generator constructed to transmit electric power to and from the secondary battery and to input and output power, and a planetary gear mechanism with three elements each connected to three shafts, the driveshaft, the output shaft of the internal combustion engine, and a rotating shaft of the generator.

In one preferable application of the first motor vehicle having the generator and the planetary gear mechanism of the invention, the motor may be connected to the driveshaft via a gear mechanism, the target drive point setting module, in the case that the detected temperature of the cooling liquid is less than the temperature threshold value, may set the target drive point based on the set power demand and the first constraint when an output torque from the motor becomes outside of a predetermined torque range including zero upon execution of ordinary control, while setting the target drive point based on the set power demand and a second constraint that is a constraint for driving the internal combustion engine at a drive point of higher rotation speed and lower torque for an identical power than the first constraint in at least a part of an operating area of the internal combustion engine, the ordinary control being control of the internal combustion engine, the generator and the motor so that the internal combustion engine is driven at the target drive point set based on the set power demand and the first constraint and the motor vehicle is driven with a driving power corresponding to the driving power demand, and, the control module may control the internal combustion engine, the generator and the motor so that the internal combustion engine is driven at the set target drive point and the motor vehicle is driven with a driving power corresponding to the driving power demand. This arrangement, in the case that the temperature of the cooling liquid is less than the temperature threshold value, enables to drive the internal combustion engine efficiently and prevents the occurrence of unusual sound or vibration from the gear mechanism caused by outputting a torque close to zero from the motor.

### BRIEF DESCRIPTION OF THE DRAWINGS

FIG. 1 schematically illustrates the configuration of a hybrid vehicle 20 in one embodiment of the invention;

FIG. 2 is a flowchart showing a drive control routine executed by a hybrid electronic control unit 70 in the embodiment;

FIG. 3 shows one example of the torque demand setting map;

FIG. 4 shows one example of an operation curve to operate an engine 22 efficiently (fuel economy optimized operation curve) used to set a target rotation speed Ne* and a target torque Te*;

FIG. 5 shows one example of NV operation curve used to set the target rotation speed Ne* and the target torque Te*;

FIG. 6 is an alignment chart showing torque-rotation speed dynamics of the respective rotational elements included in the power distribution integration mechanism 30 during the drive of the hybrid vehicle 20 with output power from the engine 22;

FIG. 7 shows one set of examples of an upper torque restriction Tm1max and a lower torque restriction Tm1min;

FIG. 8 shows one example of a torque prioritized operation curve used to set the target rotation speed Ne* and the target torque Te*;

FIG. 9 shows one example of an unusual sound reduced operation curve used to set the target rotation speed Ne* and the target torque Te*;

FIG. 10 schematically illustrates the configuration of another hybrid vehicle 120 in one modified example; and

FIG. 11 schematically illustrates the configuration of a motor vehicle 220 in another modified example.

### DESCRIPTION OF THE PREFERRED EMBODIMENTS

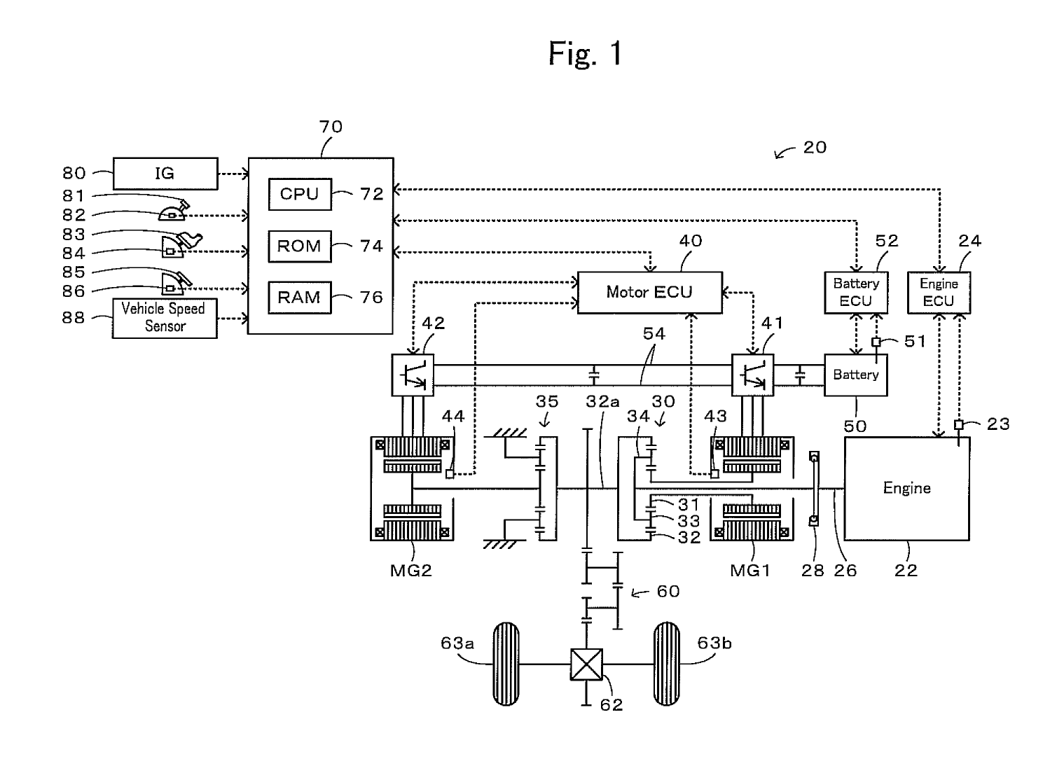

One mode of carrying out the invention is discussed below as a preferred embodiment. FIG. 1 schematically illustrates the configuration of a hybrid vehicle 20 in one embodiment of the invention. As illustrated, the hybrid vehicle 20 of the embodiment includes the engine 22, a three shaft-type power distribution integration mechanism 30 connected via a damper 28 to a crankshaft 26 or an output shaft of the engine 22, a motor MG1 connected to the power distribution integration mechanism 30 and designed to have power generation capability, a reduction gear 35 attached to a ring gear shaft 32a or a driveshaft linked with the power distribution integration mechanism 30, a motor MG2 connected to the reduction gear 35, and a hybrid electronic control unit 70 configured to control the operations of the whole hybrid vehicle 20.

The engine 22 is constructed as an internal combustion engine designed to consume a hydrocarbon fuel, such as gasoline or light oil, and thereby generate power. The engine 22 is under operation controls, such as fuel injection control, ignition control, and intake air flow control, of an engine electronic control unit (hereafter referred to as engine ECU) 24 that inputs diverse signals from various sensors, for example, a cooling water temperature Tw from a water temperature sensor 23 to detect the temperature of the cooling water that is an antifreeze compound used to exchange heat with outside air in a non-illustrated radiator and to cool down the engine 22, used to measure and detect the operating conditions of the engine 22. The engine ECU 24 establishes communication with the hybrid electronic control unit 70 to drive and control the engine 22 in response to control signals from the hybrid electronic control unit 70 and with reference to the diverse signals from the various sensors and to output data regarding the operating conditions of the engine 22 to the hybrid electronic control unit according to the requirements. The engine ECU 24 also computes a rotation speed of the crankshaft 26, which is equivalent to a rotation speed Ne of the engine 22, based on the crank position from a crank positions sensor attached to the crankshaft 26.

The power distribution integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

Both of the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements. The motor ECU 40 also performs arithmetic operations to compute rotation speeds Nm1 and Nm2 of the motors MG1 and MG2 from the output signals of the rotational position detection sensors 43 and 44.

The battery 50 is a secondary battery such as a lithium ion battery and under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 also performs various arithmetic operations for management and control of the battery 50. An accumulated charge ratio SOC of the battery 50 as a ratio of an accumulated charge amount in the battery 50 to the total capacity (storage capacity) of the battery 50 is calculated from an integrated value of the charge-discharge current Ib measured by the current sensor (not shown). An input limit Win as an allowable charging electric power to be charged in the battery 50 and an output limit Wout as an allowable discharging electric power to be discharged from the battery 50 are set corresponding to the calculated accumulated charge ratio SOC and the battery temperature Tb. A concrete procedure of setting the input and output limits Win and Wout of the battery 50 sets base values of the input limit Win and the output limit Wout corresponding to the battery temperature Tb, specifies an input limit correction factor and an output limit correction factor corresponding to the accumulated charge ratio SOC of the battery 50, and multiplies the base values of the input limit Win and the output limit Wout by the specified input limit correction factor and output limit correction factor to determine the input limit Win and the output limit Wout of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a.

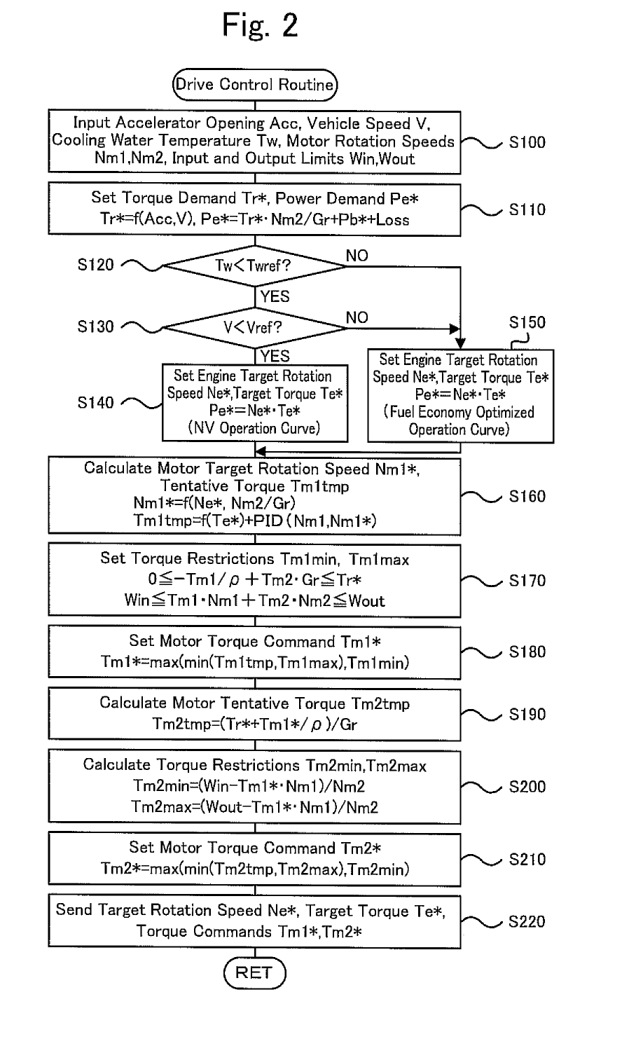

The description regards the operations of the hybrid vehicle 20 of the embodiment having the configuration discussed above. FIG. 2 is a flowchart showing a drive control routine executed by the hybrid electronic control unit 70. This routine is performed repeatedly at preset time intervals (for example, at every several msec).

In the drive control routine, the CPU 72 of the hybrid electronic control unit 70 inputs various data required for drive control, for example, the accelerator opening Acc from the accelerator pedal position sensor 84, the vehicle speed V from the vehicle speed sensor 88, the cooling water temperature Tw in the engine 22, the rotation speeds Nm1 and Nm2 of the motors MG1 and MG2, and the input limit Win and the output limit Wout of the battery 50 (step S100). The cooling water temperature Tw is detected by the water temperature sensor 23 and input from the engine ECU 24 by communication. The rotation speeds Nm1 and Nm2 of the motors MG1 and MG2 are computed from the rotational positions of the rotors in the motors MG1 and MG2 detected by the rotational position detection sensors 43 and 44 and are input from the motor ECU 40 by communication. The input limit Win and the output limit Wout of the battery 50 are set based on the battery temperature Tb and the accumulated charge ratio SOC of the battery 50 and are input from the battery ECU 52 by communication.

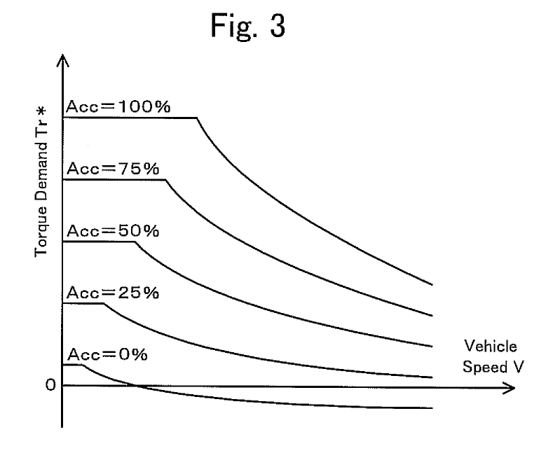

After the data input, the CPU 72 sets a torque demand Tr* to be output to the ring gear shaft 32a or the driveshaft linked with the drive wheels 63a and 63b as a torque required for the hybrid vehicle 20 based on the input accelerator opening Acc and the input vehicle speed V and sets a power demand Pe* required for the engine 22 (step S110). A concrete procedure of setting the torque demand Tr* in this embodiment provides and stores in advance variations in torque demand Tr* against the vehicle speed V with regard to various settings of the accelerator opening Acc as a torque demand setting map in the ROM 74 and reads the torque demand Tr* corresponding to the given accelerator opening Acc and the given vehicle speed V from this torque demand setting map. One example of the torque demand setting map is shown in FIG. 3. The power demand Pe* is calculated as the sum of the product of the set torque demand Tr* and a rotation speed Nr of the ring gear shaft 32a, the charge-discharge power demand Pb* to be charged into or discharged from the battery 50, and a potential loss. The rotation speed Nr of the ring gear shaft 32a is obtained by multiplying the vehicle speed V by a preset conversion factor k (Nr=k·V) or by dividing the rotation speed Nm2 of the motor MG2 by a gear ratio Gr of the reduction gear 35 (Nr=Nm2/Gr).

The CPU 72 then compares the input cooling water temperature Tw in the engine 22 with a water temperature threshold value Twref (step S120), and the CPU 72 compares the input vehicle speed V with the vehicle speed threshold value Vref when the cooling water temperature Tw is less than the water temperature threshold value Twref (step S130). In the embodiment, the water temperature threshold value Twref is, for example, defined by experiment based on the cooling capability in the non-illustrated radiator, the characteristics of the engine 22, and the characteristics of the cooling water as a lower limit value of a temperature range where a temperature rise in the cooling water of the engine 22 is to be prevented to keep the engine 22 from overheating (for example, 100° C. or 110° C.). In the embodiment, the vehicle speed threshold value Vref is, for example, defined by experiment based on the characteristics of the engine 22 and the vehicle as a lower limit value of a vehicle speed range where it is supposed that the noise or vibration caused by operation of the engine 22 in the next described muffled sound area does not give feeling of incompatibility or unpleasant feeling to a passenger (for example, 80 km/h or 90 km/h). The reason why noise or vibration caused by operation of the engine 22 does not give feeling of incompatibility or unpleasant feeling to a passenger when the vehicle speed V is high is because the noise or vibration from the engine 22 is masked by noise (road noise) or vibration while driving the vehicle.

When the cooling water temperature Tw is less than the water temperature threshold value Twref and the vehicle speed V is less than the vehicle speed threshold value Vref, it is decided not to operate the engine 22 in the muffled sound area and the CPU 72 sets a target rotation speed Ne* and a target torque Te* as a drive point (target drive point) where the engine 22 is to be driven based on the power demand Pe* of the engine 22 using an NV (noise vibration) operation curve (step S140). The NV operation curve is defined by shifting a part inside of the muffled sound area on an operation curve to operate the engine 22 efficiently (in the embodiment, a fuel economy optimized operation curve appropriate for enhancing the operating efficiency of the engine 22) towards the higher rotation speeds side (lower torque side) to the outside of the muffled sound area. On the other hand, when the cooling water temperature Tw is less than the water temperature threshold value Twref and the vehicle speed V is not less than the vehicle speed threshold value Vref, it is decided to be able to operate the engine 22 in the muffled sound area and the CPU 72 sets the target rotation speed Ne* and the target torque Te* as a drive point (target drive point) where the engine 22 is to be driven based on the power demand Pe* of the engine 22 using the operation curve to operate the engine 22 efficiently (step S150).

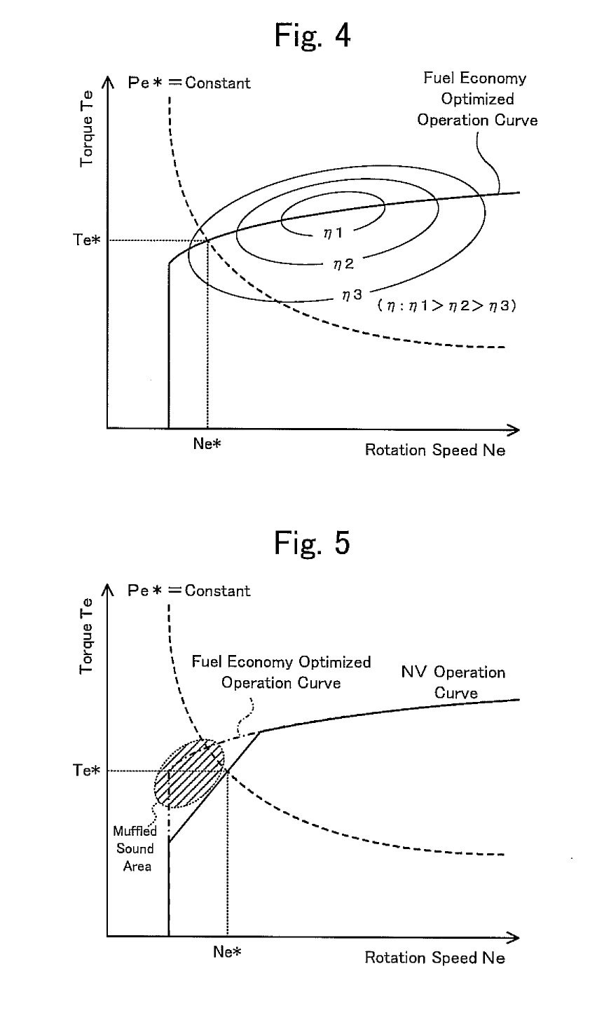

FIG. 4 shows a fuel economy optimized operation curve as one example of an operation curve to operate the engine 22 efficiently used to set the target rotation speed Ne* and the target torque Te*, and FIG. 5 shows one example of NV operation curve used to set the target rotation speed Ne* and the target torque Te*. In FIG. 4, the operating efficiency η of the engine 22 is also shown for reference. In FIG. 5, the muffled sound area is shown (illustrated as a diagonally shaded area) for explanation and the fuel economy optimized operation curve is also indicated by alternate long and short dashed lines for reference. As clearly shown in the both figures, the target rotation speed Ne* and the target torque Te* are given as an intersection of each operation curve and a curve of constant power demand Pe* (=Ne*×Te*). The muffled sound area is an area of lower rotation speeds and higher torque side in the operable area of the engine 22 and is an area where the so-called muffled sound or vibration occurs and may give feeling of incompatibility or unpleasant feeling to a passenger. The fuel economy optimized operation curve is an appropriate operation curve for enhancing the operating efficiency η of the engine 22 and thereby is considered as an operation curve appropriate for reducing heat loss (thermal radiation amount from cylinder surface to the cooling water, that is, so-called cooling loss) in the engine 22.

The CPU 72 subsequently calculates a target rotation speed Nm1* of the motor MG1 from the target rotation speed Ne* of the engine 22, the rotation speed Nm2 of the motor MG2, and a gear ratio ρ of the power distribution integration mechanism 30 according to Equation (1) given below, while calculating a tentative torque Tm1tmp as a provisional value of torque to be output from the motor MG1 from the calculated target rotation speed Nm1* and the input rotation speed Nm1 of the motor MG1 according to Equation (2) given below (step S160):

Nm1*=Ne*·(1+ρ)/ρ−Nm2/(Gr·ρ) (1)

Tm1tmp=ρ·Te*/(1+ρ)+k1(Nm1*−Nm1)+k2∫(Nm1*−Nm1)dt (2)

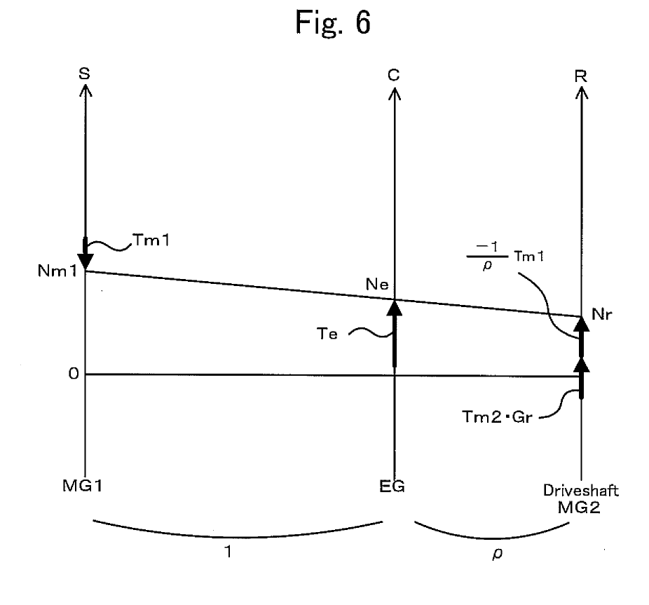

Equation (1) is a dynamic relational expression of respective rotational elements included in the power distribution integration mechanism 30. FIG. 6 is an alignment chart showing torque-rotation speed dynamics of the respective rotational elements included in the power distribution integration mechanism 30 during the drive of the hybrid vehicle 20 with output power of the engine 22. The left axis ‘S’ represents a rotation speed of the sun gear 31 that is equivalent to the rotation speed Nm1 of the motor MG1. The middle axis ‘C’ represents a rotation speed of the carrier 34 that is equivalent to the rotation speed Ne of the engine 22. The right axis ‘R’ represents the rotation speed Nr of the ring gear 32 obtained by dividing the rotation speed Nm2 of the motor MG2 by the gear ratio Gr of the reduction gear 35. Equation (1) is readily introduced from this alignment chart. Two thick arrows on the axis ‘R’ respectively show a torque applied to the ring gear shaft 32a by output of the torque Tm1 from the motor MG1, and a torque applied to the ring gear shaft 32a via the reduction gear 35 by output of the torque Tm2 from the motor MG2. Equation (2) is a relational expression of feedback control to drive and rotate the motor MG1 at the target rotation speed Nm1*. In Equation (2) given above, ‘k1’ in the second term and ‘k2’ in the third term on the right side respectively denote a gain of the proportional and a gain of the integral term.

The CPU 72 then sets a lower torque restriction Tm1min and an upper torque restriction Tm1max as allowable minimum and maximum torques that may be output from the motor MG1 to satisfy both Expressions (3) and (4) given below (step S170), and sets a torque command Tm1* of the motor MG1 by limiting the set tentative torque Tm1tmp with the set lower torque restriction Tm1min and lower torque restriction Tm1max according to Equation (5) below (step S180):

0≦−Tm1tmp/ρ+Tm2tmp·Gr≦Tr* (3)

Win≦Tm1·Nm1+Tm2·Nm2≦Wout (4)

Tm1*=max(min(Tm1tmp,Tm1max),Tm1min) (5)

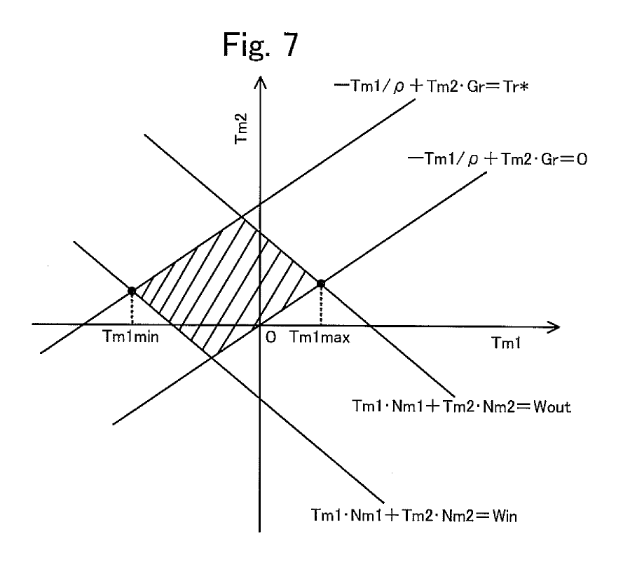

Expression (3) is a relational expression showing that the sum of the torques output from the motors MG1 and MG2 to the ring gear shaft 32a is within a range of 0 to the torque demand Tr*. Expression (4) is a relational expression showing that the sum of the electric powers input into and output from the motors MG1 and MG2 is in a range of the input limit Win and the output limit Wout of the battery 50. One set of examples of the upper torque restriction Tm1max and the lower torque restriction Tm1min is shown in FIG. 7. The upper torque restriction Tm1max and the lower torque restriction Tm1min are obtained as a maximum value and a minimum value of the tentative torque Tm1tmp in a hatched area.

The CPU 72 subsequently adds the result of division of the tentative torque Tm1tmp by the gear ratio ρ of the power distribution integration mechanism 30 to the torque demand Tr*, and specifies a tentative torque Tm2tmp as a provisional value of torque to be output from the motor MG2 by dividing the result of the addition by the gear ratio Gr of the reduction gear 35, according to Equation (6) given below (step S190):

Tm2tmp=(Tr*+Tm1tmp/ρ)/Gr (6)

The CPU 72 subsequently calculates a lower torque restriction Tm2min and an upper torque restriction Tm2max as allowable minimum and maximum torques output from the motor MG2 according to Equations (7) and (8) given below (step S200):

Tm2min=(Win−Tm1*·Nm1)/Nm2 (7)

Tm2max=(Wout−Tm1*·Nm1)/Nm2 (8)

The lower torque restriction Tm2min and the upper torque restriction Tm2max are obtained by dividing respective differences between the input limit Win or the output limit Wout of the battery 50 and power consumption (power generation) of the motor MG1, which is the product of the calculated torque command Tm1* and the current rotation speed Nm1 of the motor MG1, by the current rotation speed Nm2 of the motor MG2. The CPU 72 then limits the specified tentative torque Tm2tmp by the lower torque restriction Tm2min and upper torque restriction Tm2max according to Equation (9) given below to set a torque command Tm2* of the motor MG2 (step S210):

Tm2*=max(min(Tm2tmp,Tm2max),Tm2min) (9)

Equation (6) given above is readily introduced from the alignment chart of FIG. 6.

After setting the target rotation speed Ne* and the target torque Te* of the engine 22 and the torque commands Tm1* and Tm2* of the motors MG1 and MG2, the CPU 72 sends the settings of the target rotation speed Ne* and the target torque Te* of the engine 22 to the engine ECU 24 and the settings of the torque commands Tm1* and Tm2* of the motors MG1 and MG2 to the motor ECU 40 (step S220) and terminates the drive control routine. In response to reception of the settings of the target rotation speed Ne* and the target torque Te*, the engine ECU 24 performs required controls including intake air flow regulation, fuel injection control, ignition control of the engine 22 to operate the engine 22 at the specific drive point defined by the combination of the target rotation speed Ne* and the target torque Te*. In response to reception of the settings of the torque commands Tm1* and Tm2*, the motor ECU 40 performs switching control of the inverter 41, 42 to drive the motor MG1 with the torque command Tm1* and the motor MG2 with the torque command Tm2*. The above control described enables the torque demand Tr* to be within the range of the input limit Win and the output limit Wout of the battery 50 and to be output to the ring gear shaft 32a or the driveshaft for driving the hybrid vehicle 20 while driving the engine 22 at the target drive point set on one operation curve selected between the fuel economy optimized operation curve and the NV operation curve according to the vehicle speed V, in the case that the cooling water temperature Tw in the engine 22 is less than the water temperature threshold value Twref.

When the cooling water temperature Tw in the engine 22 is not less than the water temperature threshold value Twref at the processing of step S120, it is decided not to select the NV operation curve for setting the target drive point of the engine 22 and the CPU 72 sets the target rotation speed Ne* and the target torque Te* of the engine 22 as the target drive point of the engine 22 based on the power demand Pe* of the engine 22 using the fuel economy optimized operation curve (step S150). The CPU 72 sets the torque command Tm1* of the motor MG1 within the range of the input and output limits Win and Wout of the battery 50 based on the set target rotation speed Ne* and the target torque Te* (step S160 through S180) and sets the torque command Tm2* of the motor MG2 within the range of the input and output limits Win and Wout of the battery 50 based on the set torque demand Tr* and the set torque command Tm1* of the motor MG1 (step S190 through S210). The CPU 72 then sends the target rotation speed Ne* and the target torque Te* of the engine 22 and the torque commands Tm1* and Tm2* of the motors MG1 and MG2 respectively to the engine ECU 24 and the motor ECU 40 (step S220), and the drive control routine is terminated. The above control described enables the torque demand Tr* to be within the range of the input limit Win and the output limit Wout of the battery 50 and to be output to the ring gear shaft 32a or the driveshaft for driving the hybrid vehicle 20 while driving the engine 22 at the target drive point set on the fuel economy optimized operation curve without allowing selection of the NV operation curve, in the case that the cooling water temperature Tw in the engine 22 is not less than the water temperature threshold value Twref. Accordingly, in the case that the cooling water temperature Tw in the engine 22 is not less than the water temperature threshold value Twref, it is not allowed to drive the engine 22 at a different drive point (a drive point where the operating efficiency η is lower) from the drive point to operate the engine 22 efficiently. This effectively prevents further temperature rise in the cooling water due to increase in heat loss for outputting an identical power from the engine 22. As a result, this effectively prevents the body of the engine 22 and the surrounding parts of the engine 22 from overheating and thus effectively protects vehicle-mounted equipment and vehicle-mounted parts without increasing the cooling capability of the radiator for exchanging heat between the cooling water and the outside air, for example, by enlarging the radiator.

In the hybrid vehicle 20 of the embodiment described above, in the case that the cooling water temperature Twin the engine 22 is not less than the water temperature threshold value Twref, the target drive point of the engine 22 is set based on the fuel economy optimized operation curve and the power demand Pe* of the engine 22, without allowing selection of the NV operation curve between the fuel economy optimized operation curve to drive the engine 22 efficiently and the NV operation curve to drive the engine 22 with less efficiency than the efficiency on the fuel economy optimized operation curve in at least a part of the operating area to avoid operation in the so-called muffled area. Then, the engine 22 and the motors MG1 and MG2 are controlled so that engine 22 is driven at the target drive point and the hybrid vehicle 20 is driven with a torque corresponding to the torque demand Tr*. This effectively prevents the temperature rise in the cooling water for cooling of the engine 22 due to increase in heat loss of the engine 22, and thereby overheating of the engine 22 is effectively prevented. In the case that the cooling water temperature Tw in the engine 22 is less than the water temperature threshold value Twref, the engine 22 is driven at the set drive point on one operation curve selected between the fuel economy optimized operation curve and the NV operation curve according to the vehicle speed V. This enables to drive the engine 22 more efficiently in comparison with the case of setting the target drive point of the engine 22 using the NV operation curve regardless of the vehicle speed V, and prevents the occurrence of noise or vibration while operating the engine 22 and therefore to prevent giving feeling of incompatibility or unpleasant feeling to a passenger more effectively.

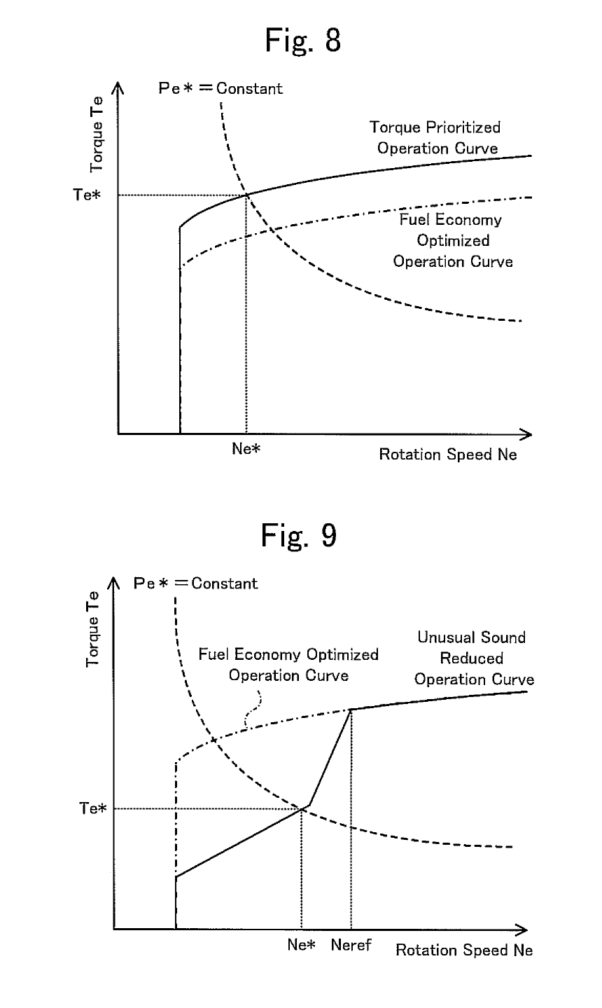

In the hybrid vehicle 20 of the embodiment, in the case that the cooling water temperature Tw is less than the water temperature threshold value Twref, the target drive point of the engine 22 is set using one selected operation curve between the fuel economy optimized operation curve and the NV operation curve according to the vehicle speed V, while setting the target drive point of the engine 22 using the fuel economy optimized operation curve without allowing selection of the NV operation curve in the case that the cooling water temperature Tw is not less than the water temperature threshold value Twref. However, this is not essential, and a torque prioritized operation curve to operate the engine 22 with higher priority given to outputting high torque than enhancing the operating efficiency η of the engine 22 may be used instead of the NV operation curve. For example, in the case that the cooling water temperature Tw is less than the water temperature threshold value Twref, the target drive point of the engine 22 may be set using one selected operation curve between the fuel economy optimized operation curve and the torque prioritized operation curve according to the accelerator opening Acc, while setting the target drive point of the engine 22 using the fuel economy optimized operation curve without allowing selection of the torque prioritized operation curve in the case that the cooling water temperature Tw is not less than the water temperature threshold value Twref. In this arrangement, in the case that the cooling water temperature Tw is less than the water temperature threshold value Twref, the target drive point may be set based on the fuel economy optimized operation curve and the power demand Pe* of the engine 22 when the accelerator opening Acc is less than an accelerator opening threshold value Accref (for example, 50% or 70%) that is predetermined, for example, by experiment, as a lower limit value of an accelerator opening range for giving a higher priority to outputting high torque than enhancing the operating efficiency η of the engine 22, while setting the target drive point based on the torque prioritized operation curve and the power demand Pe* of the engine 22 when the accelerator opening Acc is not less than the accelerator opening threshold value Accref. FIG. 8 shows one example of the torque prioritized operation curve used to set the target rotation speed Ne* and the target torque Te*. In FIG. 8, the fuel economy optimized operation curve is also indicated by alternate long and short dashed lines for reference. In FIG. 8, the torque prioritized operation curve is determined as a curve made by connecting each drive point for outputting the largest torque corresponding to each rotation speed of the engine 22. This usage of the torque prioritized operation curve enables to drive the hybrid vehicle 20 operating the engine 22 efficiently when the driver of the vehicle requires to output relatively low torque while outputting high torque from the engine 22 when the driver requires to output relatively high torque, in the case that the cooling water temperature Tw in the engine 22 is less than the water temperature threshold value Twref. In the case of controlling the engine 22 according to the setting of the target drive point of the engine 22 set with the torque prioritized operation curve, the open and close timings of an intake valve of the engine 22 may be controlled to be earlier timings (advanced side) than the ordinal timing corresponding to the target drive point though the operating efficiency η of the engine 22 is lowered, by controlling a non-illustrated variable valve timing mechanism to vary the open and close timings of the intake valve.

In the hybrid vehicle 20 of the embodiment, in the case that the cooling water temperature Tw is less than the water temperature threshold value Twref, the target drive point of the engine 22 is set using one selected operation curve between the fuel economy optimized operation curve and the NV operation curve according to the vehicle speed V, while setting the target drive point of the engine 22 using the fuel economy optimized operation curve without allowing selection of the NV operation curve in the case that the cooling water temperature Tw is not less than the water temperature threshold value Twref. However, this is not essential, and an unusual sound reduced operation curve may be used instead of the NV operation curve. The unusual sound reduced operation curve is determined to operate the engine 22 at a drive point of lower torque side (higher rotation speed side) than a drive point on the fuel economy optimized operation curve while outputting an identical power from the engine 22 in order to prevent occurrence of so-called backlash sound in the reduction gear 35 due to output of a torque within a predetermined torque range including zero from the motor MG2. For example, in the case that the cooling water temperature Tw in the engine 22 is less than the water temperature threshold value Twref, the target drive point may be set based on the fuel economy optimized operation curve and the power demand Pe* of the engine 22 when the set torque command Tm2* of the motor MG2 by the same processing of the processing of step S150 through S210 in the drive control routine of FIG. 2 becomes outside of the predetermined torque range, while setting the target drive point based on the unusual sound reduced operation curve and the power demand Pe* when the set torque command Tm2* of the motor MG2 by the same processing becomes inside of the predetermined torque range. In the case that the cooling water temperature Tw in the engine 22 is not less than the water temperature threshold value Twref, the target drive point may be set based on the fuel economy optimized operation curve without allowing selection of the unusual sound reduced operation curve. FIG. 9 shows one example of the unusual sound reduced operation curve used to set the target rotation speed Ne* and the target torque Te*. In FIG. 9, the fuel economy optimized operation curve is also indicated by alternate long and short dashed lines for reference. In FIG. 9, the unusual sound reduced operation curve is determined to operate the engine 22 at a drive point of lower torque side than a drive point on the fuel economy optimized operation curve for an identical power from the engine 22 in the area of the rotation speed Ne of the engine 22 lower than or equal to a relatively high predetermined rotation speed Neref (for example, 2500 rpm or 3000 rpm), in order for the motor MG2 to output a larger positive torque than a torque in the predetermined torque range. This usage of the unusual sound reduced operation curve enables to drive the engine 22 efficiently and effectively prevents the occurrence of unusual sound or vibration in the reduction gear 35 due to output torque close to zero from the motor MG2, in the case that the cooling water temperature Tw in the engine 22 is less than the water temperature threshold value Twref.

In the hybrid vehicle 20 of the embodiment, in the case that the cooling water temperature Tw is less than the water temperature threshold value Twref, the target drive point of the engine 22 is set using one selected operation curve between the fuel economy optimized operation curve and the NV operation curve according to the vehicle speed V. This is not essential, and the target drive point of the engine 22 may be set using the NV operation curve regardless of the vehicle speed V in the case that the cooling water temperature Tw is less than the water temperature threshold value Twref.

In the hybrid vehicle 20 of the embodiment, the torque command Tm1* of the motor MG1 is set by obtaining the upper and lower torque restrictions Tm1max and Tm1min which satisfy both Expressions (3) and (4) described above for limiting the tentative torque Tm1tmp of the motor MG1, and the torque command Tm2* of the motor MG2 is set by obtaining the upper and lower torque restrictions Tm2max and Tm2min according to Equations (7) and (8) described above. In one modified example, the torque command Tm1* of the motor MG1 may be set equivalent to the tentative torque Tm1tmp without any limitations by the upper and lower torque restrictions Tm1max and Tm1min which satisfies both Expressions (3) and ( ), and the torque command Tm2* may be set by obtaining the upper and lower torque restrictions Tm2max and Tm2min according to Equations (7) and (8) using the set the torque command Tm1* of the motor MG1.

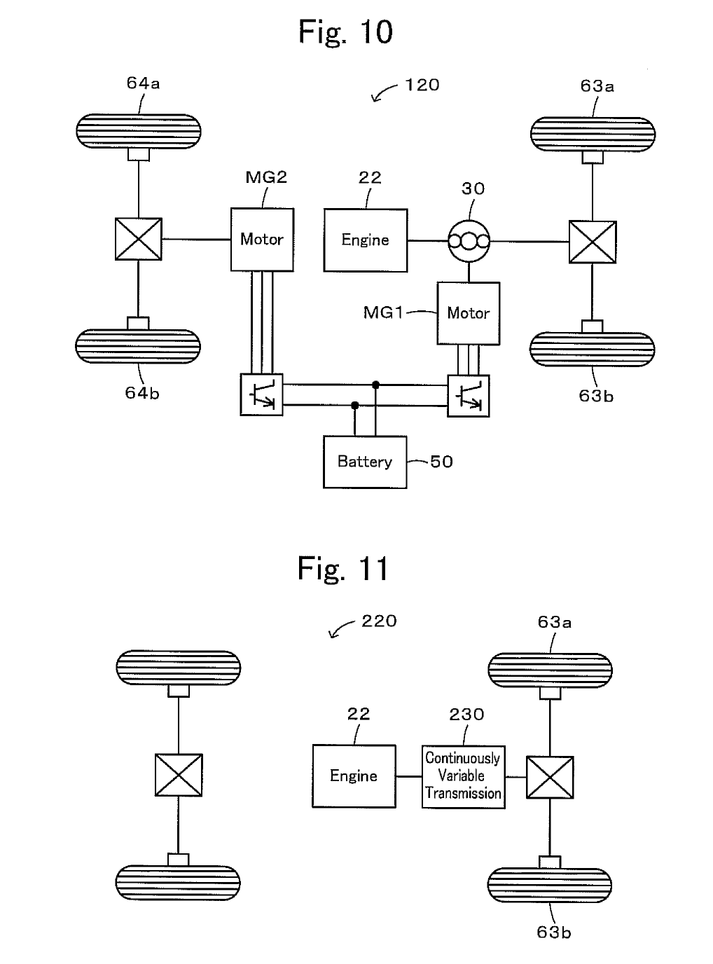

In the hybrid vehicle 20 of the embodiment, the power of the motor MG2 is converted by the reduction gear 35 and is output to the ring gear shaft 32a. The technique of the invention is also applicable to a hybrid vehicle 120 of a modified structure shown in FIG. 10. In the hybrid vehicle 120 of FIG. 10, the power of the motor MG2 is connected to another axle (an axle linked with wheels 64a and 64b) that is different from the axle connecting with the ring gear shaft 32a (the axle linked with the drive wheels 63a and 63b).

In the embodiment, the discussion is made by applying the invention to the hybrid vehicle 20 that is driven with output driving force from the engine 22 and the motor MG1 to the ring gear shaft 32a or the driveshaft via the power distribution integration mechanism 30 and output driving force from the motor MG2 to the ring gear shaft 32a via the reduction gear 35. The invention may also be applicable to another type of motor vehicle, for example, the motor vehicle 220 of FIG. 11. In the motor vehicle 220, without having the motor MG1 and the power distribution integration mechanism 30, the driving power from the engine 22 is output to the driveshaft via a continuously variable transmission (CVT) 230.

The primary elements in the embodiment and its modified examples are mapped to the primary constituents in the claims of the invention as described below. The engine 22 corresponds to the ‘internal combustion engine’ in the claims of the invention. The combination of the power distribution integration mechanism 30 and the motor MG1 corresponds to the ‘power transmitting unit’ in the claims of the invention. The water temperature sensor 23 corresponds to the ‘cooling liquid temperature detector’ in the claims of the invention. The hybrid electronic control unit 70 executing the processing of step S110 in the drive control routine of FIG. 2 to set the power demand Pe* of the engine 22 according to the torque demand Tr* corresponds to the ‘power demand setting module’ in the claims of the invention. The hybrid electronic control unit 70 executing the processing of step S120 through S150 in the drive control routine of FIG. 2 to set the target rotation speed Ne* and the target torque Te* as the target drive point of the engine 22 based on the power demand Pe* and one selected operation curve between the fuel economy optimized operation curve and the NV operation curve in the case that the cooling water temperature Tw from the water temperature sensor 23 is less than the water temperature threshold value Twref while setting the target drive point based on the power demand Pe* and the fuel economy optimized operation curve without allowing selection of the NV operation curve in the case that the cooling water temperature Tw is less than the water temperature threshold value Twref corresponds to the ‘target drive point setting module’ in the claims of the invention. The combination of the hybrid electronic control unit 70, the engine ECU 24 to drive and control the engine 22 based on the received signals, and the motor ECU 40 to control the inverters 41 and 42 to drive the motors MG1 and MG2 with the received torque commands Tm1* and Tm2* corresponds to the ‘control module’ in the claims of the invention. In the combination, the hybrid electronic control unit 70 executes the processing of step S160 through S220 in the drive control routine of FIG. 2 to set the torque commands Tm1* and Tm2* of the motors MG1 and MG2 so that the engine 22 is driven at the target drive point and the hybrid vehicle 20 is driven with the torque demand Tr* within the range of the input and output limits Win and Wout of the battery 50 to send the setting to the motor ECU 40 and to send the target drive point of the engine 22 to the engine ECU 24. The battery 50 corresponds to the ‘secondary battery’ in the claims of the invention. The motor MG2 corresponds to the ‘motor’ in the claims of the invention. The motor MG1 corresponds to the ‘generator’ in the claims of the invention. The power distribution integration mechanism 30 corresponds to the ‘planetary gear mechanism’ in the claims of the invention. The continuously variable transmission 230 also corresponds to the ‘power transmitting mechanism’ in the claims of the invention.

The ‘internal combustion engine’ is not restricted to the internal combustion engine designed to consume a hydrocarbon fuel, such as gasoline or light oil, and thereby output power, but may be any other type, for example, a hydrogen engine. The ‘power transmitting unit’ is not restricted to the combination of the power distribution integration mechanism 30 and the motor MG1 or the continuously variable transmission 230, but may any other unit that is connected with a driveshaft linked to an axle of the motor vehicle and with an output shaft of the internal combustion engine in such a manner as to be rotatable independently of the driveshaft and configured to transmit at least part of power from the output shaft to the driveshaft. The ‘cooling liquid temperature detector’ is not restricted to the water temperature sensor 23 but may be any other thing that detects a temperature of cooling liquid for cooling of the internal combustion engine. The ‘power demand setting module’ is not restricted to the arrangement of setting the power demand Pe* of the engine 22 according to the torque demand Tr* that is based on the accelerator opening Acc and the vehicle speed V, but may be any other arrangement of setting a power demand required for the internal combustion engine according to a driving power demand for driving the motor vehicle, for example, an arrangement of using the torque demand Tr* that is only based on the accelerator opening Acc. The ‘target drive point setting module’ is not restricted to the arrangement of setting the target rotation speed Ne* and the target torque Te* as the target drive point of the engine 22 based on the power demand Pe* and one selected operation curve between the fuel economy optimized operation curve and the NV operation curve in the case that the cooling water temperature Tw from the water temperature sensor 23 is less than the water temperature threshold value Twref while setting the target drive point based on the power demand Pe* and the fuel economy optimized operation curve without allowing selection of the NV operation curve in the case that the cooling water temperature Tw is less than the water temperature threshold value Twref, but may be any other arrangement of setting a target drive point where the internal combustion engine is to be driven, in a case that the detected temperature of the cooling liquid is less than a predetermined temperature threshold value, based on the set power demand and one selected constraint between a first constraint for efficient operation of the internal combustion engine and a second constraint for less efficient operation of the internal combustion engine than the first constraint in at least a part of an operating area of the internal combustion engine, while setting the target drive point based on the set power demand and the first constraint without allowing selection of the second constraint in a case that the detected temperature of the cooling liquid is not less than the temperature threshold value, or arrangement of setting a target drive point where the internal combustion engine is to be driven, in a case that the detected temperature of the cooling liquid is less than a predetermined temperature threshold value, based on the set power demand and a noise vibration constraint that is a constraint defining a relation between rotation speed and torque for efficient operation of the internal combustion engine in an operating area other than a predetermined operating area where noise or vibration caused by operation of the internal combustion engine may give feeling of incompatibility to a passenger, while setting the target drive point based on the set power demand and an efficiency constraint that is a constraint for efficient operation of the internal combustion engine in a case that the detected temperature of the cooling liquid is not less than the temperature threshold value, for example, an arrangement of using the torque prioritized operation curve or the unusual sound reduced operation curve instead of the NV operation curve. The ‘control module’ is not restricted to the combination of the hybrid electronic control unit 70 with the engine ECU 24 and the motor ECU 40 but may be actualized by a single electronic control unit. The ‘control module’ is not restricted to the arrangement of driving and controlling the engine 22 based on the target drive point and controlling the inverters 41 and 42 to drive the motors MG1 and MG2 with the torque commands Tm1* and Tm2*, but may be any other arrangement of controlling the internal combustion engine and the power transmitting unit so that the internal combustion engine is driven at the set target drive point and the motor vehicle is driven with a driving power corresponding to the driving power demand. The ‘secondary battery’ is not restricted to the battery 50 but any other type other than a lithium ion battery, for example, a nickel metal hydride battery, a nickel cadmium battery, and a lead acid battery. The ‘motor’ is not restricted to the motor MG2 constructed as a synchronous motor generator but may be any type of motor constructed to transmit electric power to and from the secondary battery and to input and output power from and to the driveshaft, for example, an induction motor. The ‘planetary gear mechanism’ is not restricted to the power distribution integration mechanism 30 but may be any other mechanism with three elements each connected to three shafts, the driveshaft, the output shaft of the internal combustion engine, and a rotating shaft of the generator, for example, a structure adopting a double pinion-type planetary gear mechanism other than a single pinion-type planetary gear mechanism, a structure adopting a combination of multiple planetary gear mechanisms. The ‘generator’ is not restricted to the motor MG1 constructed as a synchronous motor generator but may be any type of generator constructed to transmit electric power to and from the secondary battery and to input and output power, for example, an induction motor.

The above mapping of the primary elements in the embodiment and its modified examples to the primary constituents in the claims of the invention is not restrictive in any sense but is only illustrative for concretely describing the modes of carrying out the invention. Namely the embodiment and its modified examples discussed above are to be considered in all aspects as illustrative and not restrictive.

There may be many other modifications, changes, and alterations without departing from the scope or spirit of the main characteristics of the present invention.

The technique of the invention is preferably applied to the manufacturing industries of the motor vehicles.

The disclosure of Japanese Patent Application No. 2010-264569 filed on Nov. 29, 2010 including specification, drawings and claims is incorporated herein by reference in its entirety.

What is claimed is:

1. A motor vehicle, comprising:
an internal combustion engine;
a power transmitting unit that is connected with a driveshaft linked to an axle of the motor vehicle and with an output shaft of the internal combustion engine in such a manner as to be rotatable independently of the driveshaft and configured to transmit at least part of power from the output shaft to the driveshaft;
a cooling liquid temperature detector that detects a temperature of cooling liquid for cooling of the internal combustion engine;
a power demand setting module that sets a power demand required for the internal combustion engine according to a driving power demand for driving the motor vehicle;
a target drive point setting module that sets a target drive point where the internal combustion engine is to be driven, in a case that the detected temperature of the cooling liquid is less than a predetermined temperature threshold value, based on the set power demand and one selected constraint between a first constraint for efficient operation of the internal combustion engine and a second constraint for less efficient operation of the internal combustion engine than the first constraint in at least apart of an operating area of the internal combustion engine, while setting the target drive point based on the set power demand and the first constraint without allowing selection of the second constraint in a case that the detected temperature of the cooling liquid is not less than the temperature threshold value; and
a control module that controls the internal combustion engine and the power transmitting unit so that the internal combustion engine is driven at the set target drive point and the motor vehicle is driven with a driving power corresponding to the driving power demand.

2. The motor vehicle in accordance with claim 1, wherein the target drive point setting module sets the target drive point using, as the temperature threshold value, a lower limit value of a temperature range where a temperature rise in the cooling liquid is to be prevented.

3. The motor vehicle in accordance with claim 1, wherein the target drive point setting module sets the target drive point using, as the second constraint, a constraint defining a relation between rotation speed and torque for efficient operation of the internal combustion engine in an operating area other than a predetermined operating area where noise or vibration caused by operation of the internal combustion engine may give feeling of incompatibility to a passenger.

4. The motor vehicle in accordance with claim 3, wherein the target drive point setting module, in the case that the detected temperature of the cooling liquid is less than the temperature threshold value, sets the target drive point based on the set power demand and the first constraint when a vehicle speed of the motor vehicle is not less than a vehicle speed threshold value predetermined as a lower limit value of a vehicle speed range where it is supposed that the noise or vibration does not give feeling of incompatibility to a passenger, while setting the target drive point based on the set power demand and the second constraint when the vehicle speed is less than the vehicle speed threshold value.

5. The motor vehicle in accordance with claim 1, wherein the target drive point setting module sets the target drive point using, as the second constraint, a constraint defining a relation between rotation speed and torque for giving a higher priority to outputting torque than efficient operation of the internal combustion engine.

6. The motor vehicle in accordance with claim 1, the motor vehicle further having:
a secondary battery; and
a motor constructed to transmit electric power to and from the secondary battery and to input and output power from and to the driveshaft,
wherein the power transmitting unit has a generator constructed to transmit electric power to and from the secondary battery and to input and output power, and a planetary gear mechanism with three elements each connected to three shafts, the driveshaft, the output shaft of the internal combustion engine, and a rotating shaft of the generator.

7. A motor vehicle, comprising:
an internal combustion engine;
a power transmitting unit that is connected with a driveshaft linked to an axle of the motor vehicle and with an output shaft of the internal combustion engine in such a manner as to be rotatable independently of the driveshaft and configured to transmit at least part of power from the output shaft to the driveshaft;
a cooling liquid temperature detector that detects a temperature of cooling liquid for cooling of the internal combustion engine;
a power demand setting module that sets a power demand required for the internal combustion engine according to a driving power demand for driving the motor vehicle;
a target drive point setting module that sets a target drive point where the internal combustion engine is to be driven, in a case that the detected temperature of the cooling liquid is less than a predetermined temperature threshold value, based on the set power demand and a noise vibration constraint that is a constraint defining a relation between rotation speed and torque for efficient operation of the internal combustion engine in a operating area other than a predetermined operating area where noise or vibration caused by operation of the internal combustion engine may give feeling of incompatibility to a passenger, while setting the target drive point based on the set power demand and an efficiency constraint that is a constraint for efficient operation of the internal combustion engine in a case that the detected temperature of the cooling liquid is not less than the temperature threshold value; and
a control module that controls the internal combustion engine and the power transmitting unit so that the internal combustion engine is driven at the set target drive point and the motor vehicle is driven with a driving power corresponding to the driving power demand.

8. The motor vehicle in accordance with claim 7, wherein the target drive point setting module sets the target drive point using, as the temperature threshold value, a lower limit value of a temperature range where a temperature rise in the cooling liquid is to be prevented.

9. The motor vehicle in accordance with claim 7, the motor vehicle further having:
a secondary battery; and
a motor constructed to transmit electric power to and from the secondary battery and to input and output power from and to the driveshaft,
wherein the power transmitting unit has a generator constructed to transmit electric power to and from the secondary battery and to input and output power, and a planetary gear mechanism with three elements each connected to three shafts, the driveshaft, the output shaft of the internal combustion engine, and a rotating shaft of the generator.
